(19) United States
(12) Patent Application Publication
(10) Pub. No.: US 2019/0345833 A1
(43) Pub. Date: Nov. 14, 2019

(54) VANE INCLUDING INTERNAL RADIANT HEAT SHIELD

(71) Applicant: United Technologies Corporation, Farmington, CT (US)

(72) Inventors: Lane Mikal Thornton, Tolland, CT (US); Adam P. Generale, Dobbs Ferry, NY (US)

(21) Appl. No.: 15/977,331

(22) Filed: May 11, 2018

(51) Int. Cl. F01D 9/04; F01D 25/00; F01D 25/12

(52) U.S. Cl. CPC F01D 9/041; F01D 25/005; F01D 25/12; F05D 2260/231; F05D 2300/177; F05D 2300/6033; F05D 2220/32

(57) ABSTRACT

A component for a gas turbine engine includes an airfoil shell having an internal cavity and extending between a radially inner platform and a radially outer platform. The component also includes a spar disposed within the internal cavity. The airfoil shell has a greater resistance to heat than the spar, and the spar has a greater strength than the airfoil shell. A radiant heat shield circumscribes the spar within the internal cavity. The radiant heat shield is enclosed within the airfoil shell and has a reflectance to radiant heat that is greater than or equal to that of the spar.

### BACKGROUND

This application relates to vanes, and more particularly to a vane having a radiant heat shield.

A gas turbine engine typically includes a fan section, a compressor section, a combustor section, and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section.

The turbine section includes components such as turbine vanes that are subjected to high temperatures during engine operation. Conventional turbine vanes have been made of a single crystal nickel superalloy that forms an aerodynamic surface of the vane as well as carrying any structural loads. More recently, it has been proposed to form vanes of a non-metallic material, such as a ceramic matrix composite (CMC). CMC vanes can withstand higher operating temperatures than a single crystal nickel superalloy, but cannot support structural loads as well as the single crystal nickel superalloy vanes.

### SUMMARY

A component for a gas turbine engine according to an example of the present disclosure includes an airfoil shell having an internal cavity and extending between a radially inner platform and a radially outer platform. The component also includes a spar disposed within the internal cavity. The airfoil shell has a greater resistance to heat than the spar, and the spar has a greater strength than the airfoil shell. A radiant heat shield circumscribes the spar within the internal cavity. The radiant heat shield is enclosed within the airfoil shell and has a reflectance to radiant heat that is greater than or equal to that of the spar.

In a further embodiment of any of the foregoing embodiments, the radiant heat shield is at least partially spaced apart from an outer surface of the spar and an inner surface of the airfoil shell.

In a further embodiment of any of the foregoing embodiments, the airfoil shell includes a plurality of lateral extensions that extend away from the inner surface of the airfoil shell and space the radiant heat shield away from the inner surface of the airfoil shell.

In a further embodiment of any of the foregoing embodiments, the outer surface of the spar includes a plurality of lateral extensions that extend away from the outer surface of the spar and space the radiant heat shield away from the outer surface of the spar.

In a further embodiment of any of the foregoing embodiments, the radiant heat shield continuously circumscribes the spar between the radially inner platform and the radially outer platform.

In a further embodiment of any of the foregoing embodiments, the radiant heat shield discontinuously circumscribes the spar between the radially inner platform and the radially outer platform.

In a further embodiment of any of the foregoing embodiments, the radiant heat shield continuously circumscribes a portion of the spar that extends from one of the radially inner platform and the radially outer platform.

In a further embodiment of any of the foregoing embodiments the radiant heat shield includes a first portion that continuously circumscribes a portion of the spar that extends from the radially inner platform, and also includes a second portion that is separate from the first portion and circumscribes a portion of the spar that extends from the radially outer platform.

In a further embodiment of any of the foregoing embodiments, the spar includes a nickel alloy.

In a further embodiment of any of the foregoing embodiments, the airfoil shell includes a ceramic matrix composite (CMC) or an alloy comprising one or more of niobium, tantalum, tungsten, rhenium, and molybdenum.

In a further embodiment of any of the foregoing embodiments, the radiant heat shield includes an alloy comprising one or more of nickel, cobalt, and gold.

In a further embodiment of any of the foregoing embodiments, the spar includes a nickel alloy; the airfoil shell includes a ceramic matrix composite (CMC) or an alloy comprising one or more of niobium, tantalum, tungsten, rhenium, and molybdenum; and the radiant heat shield includes an alloy comprising one or more of nickel, cobalt, and gold.

In a further embodiment of any of the foregoing embodiments, the radiant heat shield has an emissivity that is 1-50%.

In a further embodiment of any of the foregoing embodiments, the radiant heat shield has a reflectance that is 50-99%.

In a further embodiment of any of the foregoing embodiments, the radiant heat shield has an absorptivity that is 1-80%.

In a further embodiment of any of the foregoing embodiments, the airfoil shell defines a first wall having a first thickness measured perpendicular to an outer surface of the spar, and the radiant heat shield defines a second wall having a second thickness measured perpendicular to the outer surface of the spar, and the first thickness is at least twice the second thickness.

In a further embodiment of any of the foregoing embodiments, a portion of an internal cavity between the spar and the radiant heat shield is in fluid communication with a source of cooling air.

In a further embodiment of any of the foregoing embodiments, the airfoil shell is part of a turbine vane.

A component for a gas turbine engine, according to an example of the present disclosure includes an airfoil shell having an internal cavity and extending between a radially inner platform and a radially outer platform. The airfoil shell includes a ceramic matrix composite (CMC) or an alloy including one or more of niobium, tantalum, tungsten, rhenium, and molybdenum. A spar is disposed within the internal cavity. The airfoil shell has a greater resistance to heat than the spar, and the spar has a greater strength than the airfoil shell. The spar includes a nickel alloy. A radiant heat shield circumscribes the spar within the internal cavity. The radiant heat shield is enclosed within the airfoil shell and has a reflectance to radiant heat that is greater than or equal to that of the spar. The radiant heat shield includes an alloy comprising one or more of nickel, cobalt, and gold. The radiant heat shield is at least partially spaced apart from an outer surface of the spar and an inner surface of the airfoil shell. The radiant heat shield has an emissivity that is 1-50%, a reflectance that is 50-99%, and an absorptivity that is 1-80%.

A gas turbine engine according to an example of the present disclosure includes a compressor section, a combustor section in fluid communication with the compressor section, and a turbine section in fluid communication with the combustor section. The turbine section includes a turbine vane. The turbine vane includes an airfoil shell having an internal cavity and extending between a radially inner platform and a radially outer platform. A spar is disposed within the internal cavity. The airfoil shell has a greater resistance to heat than the spar, and the spar has a greater strength than the airfoil shell. A radiant heat shield circumscribes the spar within the internal cavity. The radiant heat shield is enclosed within the airfoil shell and has a reflectance to radiant heat that is greater than or equal to that of the spar.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

FIG. 1 is a schematic view of an example gas turbine engine.

FIG. 2 is a schematic view of a portion of a gas turbine engine.

FIG. 3A is a cross-sectional view of a turbine vane of FIG. 2 taken along line B-B of FIG. 2.

FIG. 3B is a schematic view of an example radiant heat shield spacing configuration for a turbine vane.

FIG. 3C is a schematic view of another example radiant heat shield spacing configuration for a turbine vane.

FIG. 3D is a schematic view of another example radiant heat shield spacing configuration for a turbine vane.

FIG. 3E is an enlarged view of a portion of FIG. 3A.

FIG. 4A is a schematic view of an example turbine vane.

FIG. 4B is a schematic view of another example turbine vane.

FIG. 4C is a schematic view of another example turbine vane.

FIG. 5 is a schematic view of an example arrangement for securing a radiant heat shield to a radially inner platform.

### DETAILED DESCRIPTION

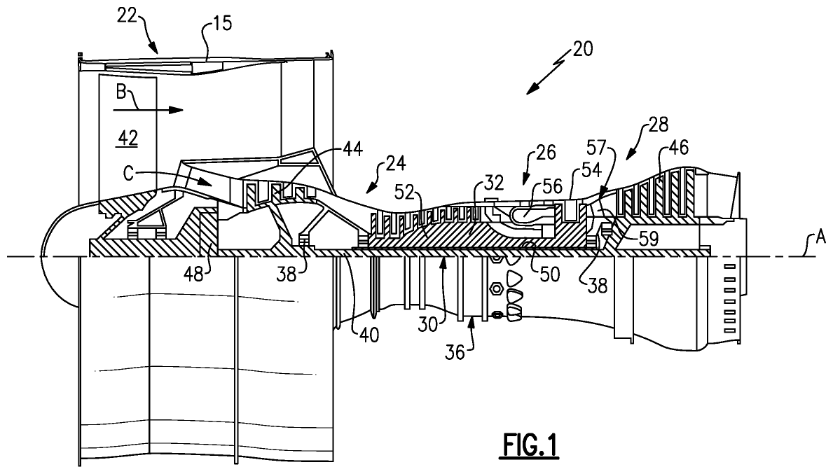

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. The fan section 22 drives air along a bypass flow path B in a bypass duct defined within a nacelle 15, and also drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,668 meters). The flight condition of 0.8 Mach and 35,000 ft (10,668 meters), with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 meters/second).

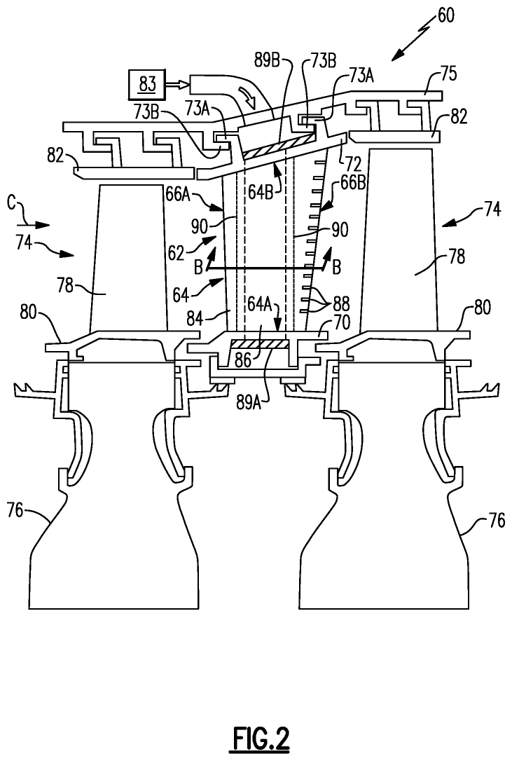

FIG. 2 shows a schematic view of selected portions of a section 60 of a gas turbine engine, such as a portion of the turbine section 28 of the gas turbine engine 20 of FIG. 1. In this example, the section 60 includes a vane section 62 having a stator vane 64 that has an airfoil shape and has a leading edge 66A and a trailing edge 66B. The vane 64 extends between a radially inner platform 70 and a radially outer platform 72. In this disclosure, “radially inner” and “radially outer” refer to the engine central longitudinal axis A. In the example of FIG. 2, the radially outer platform 72 includes hooks 73A that engage hooks 73B of engine case 75.

The vane section 62 is spaced axially away from rotor sections 74 with respect to the engine central longitudinal axis A. The rotor sections 74 each include a rotor disk 76 carrying one or more blades 78 extending from a platform 80 for rotation about the engine central longitudinal axis A. In the example of FIG. 2, the rotor sections 74 also include a blade outer air seal 82 (“BOAS”) situated radially outward of the blades 78.

The vane 64 includes an internal cavity 84 that extends radially outward from the radially inner platform 70 to the radially outer platform 72. The internal cavity 84 is in fluid communication with a source 83 of cooling air. The vane 64 includes a plurality of trailing edge openings 88 that allow the cooling air to exit through the trailing edge 66B.

A first end 64A of the vane 64 extends to the radially inner platform 70, and the opposite second end 64B of the vane 64 extends to the radially outer platform 72. In one example, the vane 64 is connected as a single component with the radially inner platform 70 and radially outer platform 72.

A spar 86 is disposed within the internal cavity 84. The spar 86 extends between the radially inner platform 70 and the radially outer platform 72, and defines a primary load path between the platforms 70, 72. In the non-limiting example of FIG. 2, the spar 86 is held in place by plate 89A that abuts the radially inner platform 70 and plate 89B that abuts the radially outer platform 72. However, other attachment arrangements could be used, such as one in which the spar 86 engaged hooks 73B of engine case 75 (e.g., by being integral with the hooks 73A of the radially outer platform 72).

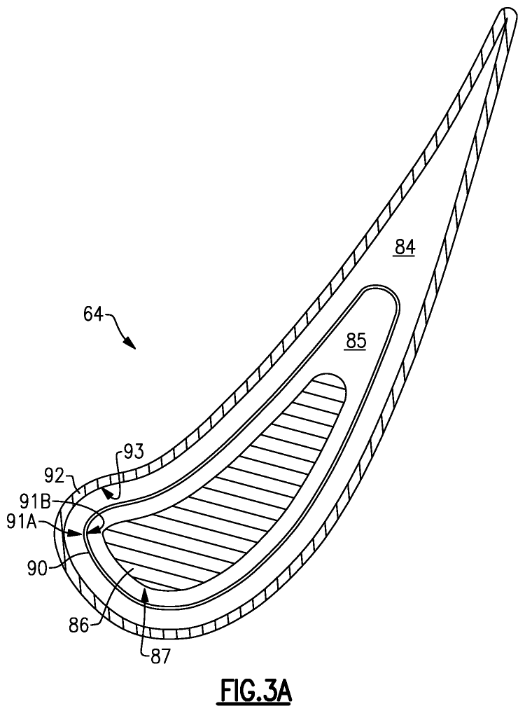

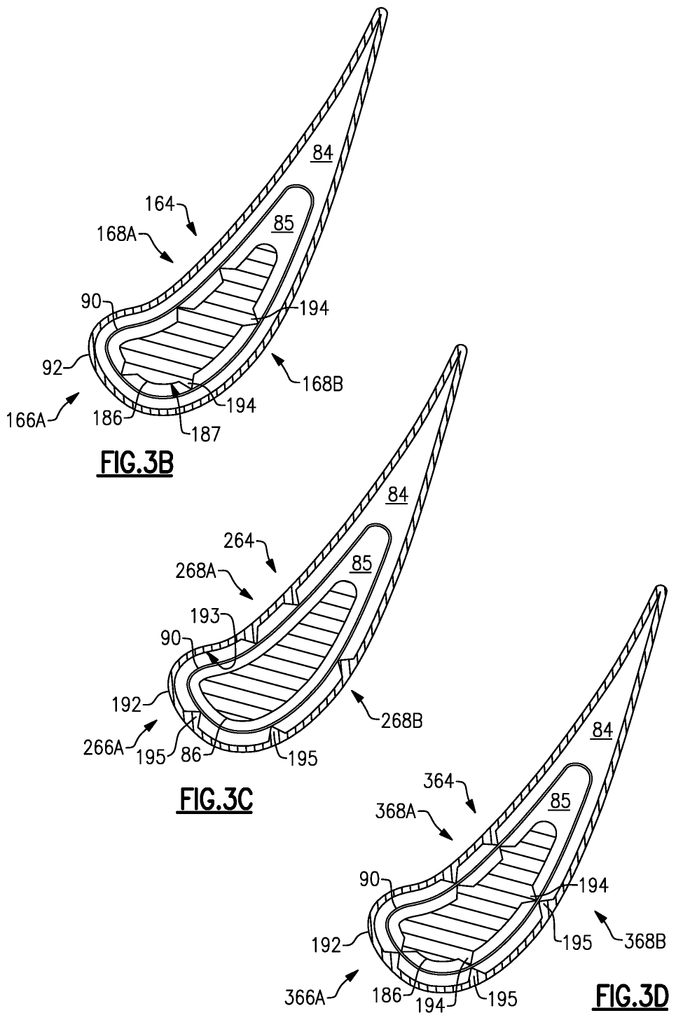

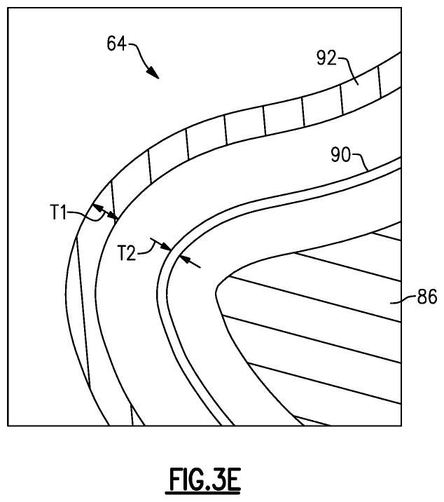

A radiant heat shield 90 is also disposed within the internal cavity and circumscribes the spar 86. The radiant heat shield 90 protects the spar 86 from radiant heat from an interior of an airfoil shell 92 of the vane 64 (see FIG. 3), and has a reflectance to radiant heat that is greater than or equal to that of the spar 86. In some examples (e.g., where the spar 86 and radiant heat shield 90 are composed of different materials), a reflectance of the radiant heat shield 90 is greater than that of the spar 86. In the example of FIG. 2, the radiant heat shield 90 continuously circumscribes the spar 86 between the radially inner platform 70 and the radially outer platform 72. In one example, the radiant heat shield 90 is substantially non-load bearing.

FIG. 3A is a cross-sectional view of the turbine vane 64 of FIG. 2 taken along line B-B of FIG. 2. Referring now to FIG. 3A with continued reference to FIG. 2, the vane 64 includes an airfoil shell 92 that defines the internal cavity 84. The airfoil shell 92 has a greater resistance to heat than the spar 86, and the spar 86 has a greater strength than the airfoil shell 92.

The radiant heat shield 90 is enclosed within the airfoil shell 92. As used herein, the radiant heat shield 90 being “enclosed within” the airfoil shell 92 means that no portion of the radiant heat shield 90 extends outside of the airfoil shell 92.

A portion 85 of the internal cavity 84 is provided between the spar 86 and the radiant heat shield 90. The portion 85 is in fluid communication with the source 83 of cooling air. The radiant heat shield 90 segments portion 85 of the internal cavity 84, and thereby concentrates a flow of cooling air within the portion 85. By segmenting the portion 85 from the larger internal cavity 84, the radiant heat shield 90 enhances convective cooling of the cooling air from source 83 within the portion 85, because the cooling area is concentrated in a smaller area. Also, because the cooling air within the portion 85 is segmented from the hotter temperature air in the internal cavity outside of the portion 85, the exit temperature of the cooling air is reduced, making it more useful for cooling downstream components (e.g., downstream blades).

The radiant heat shield 90 protects the spar 86 from a radiant heat load applied to the airfoil shell 92. The radiant heat shield 90 has a reflectance, an emissivity, and an absorptivity, each of which are measurable on a scale of 0%-100%. The reflectance refers to a degree to which the radiant heat shield 90 reflects radiant heat away from itself. The absorptivity refers to a degree to which the radiant heat shield 90 absorbs incident radiant heat. The emissivity refers to a degree to which the radiant heat shield re-emits radiant heat from its interior surface 91B that the radiant heat shield 90 absorbs from its exterior surface 91A. In one example, the radiant heat shield 90 includes one or any combination of the following attributes: a reflectance that is 50-99%, an emissivity that is 1-50%, and an absorptivity that is 1-80%. In one example, the radiant heat shield 90 includes a coating, such as magnesium fluoride (MgF₂) or calcium fluoride (CaF₂) to improve its reflectance. The radiant heat shield 90 could be polished to improve its reflectivity after coating, or without a coating.

As shown in FIG. 3A, the radiant heat shield 90 is spaced apart from an inner surface 93 of the airfoil shell 92, and is also spaced away from an outer surface 87 of the spar 86. In one example, the radiant heat shield 90 does not contact the airfoil shell 92 and also does not contact the spar 86. Optionally, spacers can be utilized to maintain that spacing.

In this disclosure, like reference numerals designate like elements where appropriate and reference numerals with the addition of one-hundred or multiples thereof designate modified elements that are understood to incorporate the same features and benefits of the corresponding elements.

FIG. 3B is a schematic view of a turbine vane 164 using a first example spacing configuration for the radiant heat shield 90. The turbine vane 164 includes a pressure side 168A and a suction side 168B. In the example of FIG. 3B, the spar 186 includes a plurality of lateral extensions 194 that extend way from the outer surface 187 of the spar 186 and space the radiant heat shield 90 away from the outer surface 187 of the spar 186. In particular, the extensions 194 are disposed along a pressure side 168A, suction side 168B, and leading edge 166A of the vane 164.

FIG. 3C is a schematic view of a turbine vane 264 using a second example spacing configuration for the radiant heat shield 90. In the example of FIG. 3C, the airfoil shell 192 includes a plurality of lateral extensions 195 that extend way from the inner surface 193 of the spar airfoil shell 192 and space the radiant heat shield 90 away from the inner surface 193 of the airfoil shell 192. In particular, the lateral extensions 195 are disposed along a pressure side 268A, suction side 268B, and leading edge 266A of the vane 264.

FIG. 3D is a schematic view of a turbine vane 364 using a third example spacing configuration for the radiant heat shield 90 that utilizes the spar 186 of FIG. 3B and the airfoil shell 192 of FIG. 3C such that each of the spar 186 and airfoil shell 192 include respective lateral extensions 194, 195. In the example of FIG. 3D, the lateral extensions 194, 195 are disposed along a pressure side 368A, suction side 368B, and leading edge 366A of the vane 364.

FIG. 3E is an enlarged view of a portion of FIG. 3A. As shown in the example of FIG. 3E, the airfoil shell 92 defines a first wall having a thickness T1 measured perpendicular to the outer surface 87 of the spar. The radiant heat shield 90 defines a second wall having a thickness T2 measured perpendicular to the outer surface 87 of the spar. In the non-limiting example of FIG. 3E, the thickness T1 is at least twice the thickness T2. It is understood, however, that other thicknesses could be used.

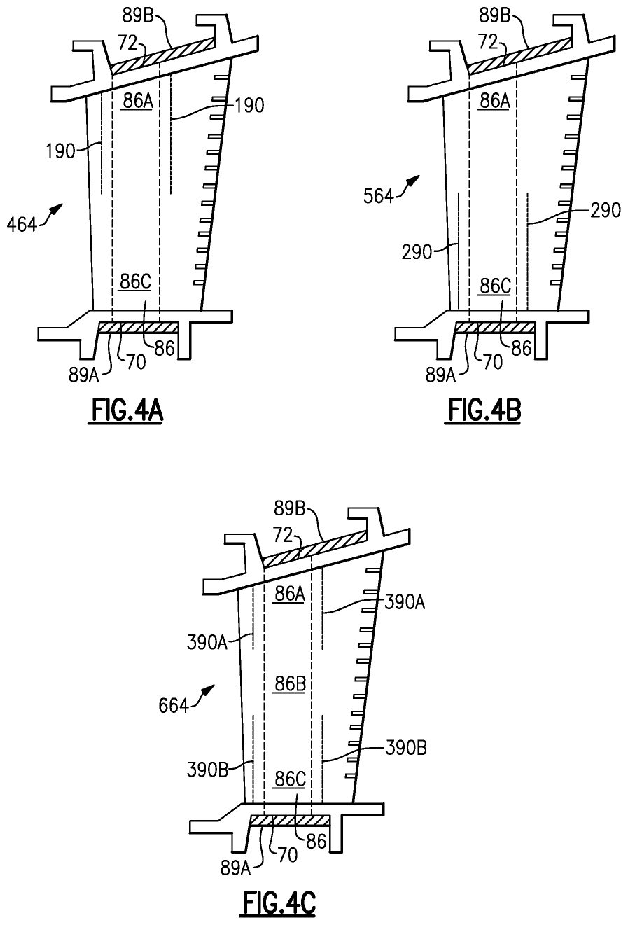

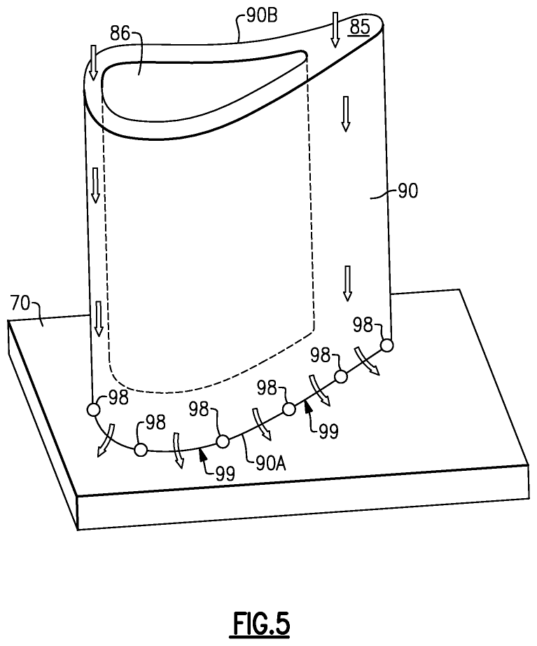

FIG. 4A is a schematic view of an example turbine vane 464 in which the radiant heat shield 190 discontinuously circumscribes the spar 86 between the radially inner platform 70 and the radially outer platform 72. In particular, the radiant heat shield 190 circumscribes a portion 86A of the spar 86 that extends from the radially outer platform 72, but does not circumscribe a portion 86C of the spar 86 that extends from the radially inner platform 70.

FIG. 4B is a schematic view of another example turbine vane 564 in which radiant heat shield 290 discontinuously circumscribes the spar 86 between the radially inner platform 70 and the radially outer platform 72. In particular, the radiant heat shield 290 circumscribes a portion 86C of the spar 86 that extends from the radially inner platform 70, but does not circumscribe portion 86A of the spar 86 that extends from the radially outer platform 72.

FIG. 4C is a schematic view of another example turbine vane 564 in which radiant heat shield 390 discontinuously circumscribes the spar 86 between the radially inner platform 70 and the radially outer platform 72. In particular, the radiant heat shield 390 includes a first portion 390A that continuously circumscribes the portion 86A of the spar 86 that extends from the radially outer platform 72, and includes a second portion 390B that is separate from the first portion 390A and circumscribes the portion 86C of the spar 86 that extends from the radially inner platform 70. In the example of FIG. 4C, the radiant heat shield 390 does not circumscribe an intermediate portion 86B that is between the portions 86A, 86C of the spar 86. In one example, the radiant heat shields 190, 290, 390 of FIGS. 4A-C provide a weight savings over the radiant heat shield 90 of FIG. 2 by using less material.

The spacing configurations shown in any of FIGS. 3B-3D could be used in the embodiments of any of FIGS. 2 and 4A-C to maintain a desired offset between the radiant heat shield 90 and one or both of the spar 86 and airfoil shell 92.

The airfoil shell 92 is formed of a high-temperature material that is capable of withstanding extended continuous operation at high temperatures (e.g., on the order of 2200° F. and above). Some example high temperature materials include a ceramic matrix composite (CMC) and alloys that contain one or more of niobium, tantalum, tungsten, rhenium, molybdenum.

In one example, the spar is at least partially composed of a nickel alloy. In one example, the spar 86 is composed of a different material than the radiant heat shield 90 and the airfoil shell 92.

In one example, the radiant heat shield 90 includes an alloy of one or more of nickel, cobalt, and gold. In one example, the radiant heat shield 90 is made from the same material as either the airfoil shell 92 or the spar 86. In one example, the radiant heat shield 90 is made of sheet metal.

FIG. 5 schematically illustrates an example of how a first end 90A of the radiant heat shield 90 can be secured to the radially inner platform 70 using a plurality of tack welds 98. In this example, the entirety of first end 90A of the radiant heat shield is not sealed to the radially inner platform 70, which provides passages 99 between end 90A of the radiant heat shield 90 and the radially inner platform 70, and between the tack welds 98. The passages 99 permit a flow of cooling air from the portion 85 of the cavity between the spar 86 and radiant heat shield 90 to flow radially inward from the source 83 of cooling air, and then to exit the portion 85 through between the tack welds 98, and then exit the trailing edge openings 88 shown in FIG. 2. Although not shown in FIG. 5, the opposite second end 90B of the radiant heat shield could be secured to the radially outer platform 72 in a similar manner using a plurality of tack welds and passages between the second end 90B and the radially outer platform 72.

The spar 86 provides a primary load path between the radially inner platform 70 and radially outer platform 72, and bears a load that in the prior art would have been borne primarily by the exterior of the vane 64. The spar 86 can support a greater structural load than the airfoil shell 92, but may be unable to withstand the same temperatures as the airfoil shell 92. The radiant heat shield 90 mitigates application of radiant heat from the airfoil shell 92 to the spar 86, and thereby facilitates the use of an airfoil shell 92 that is well-suited for operation in high temperatures (and that needs less structural load bearing capability), and use of a spar 86 that is well-suited for load bearing (and that needs less high temperature operation capability).

Although turbine vanes, are discussed in the examples above, it is understood that the vane features discussed above could be applied to other vanes of a gas turbine engine, such as vanes in the compressor section 24.

Although example embodiments have been disclosed, a worker of ordinary skill in this art would recognize that certain modifications would come within the scope of this disclosure. For that reason, the following claims should be studied to determine the scope and content of this disclosure.

What is claimed is:

1. A component for a gas turbine engine, comprising:
an airfoil shell having an internal cavity and extending between a radially inner platform and a radially outer platform;
a spar disposed within the internal cavity, the airfoil shell having a greater resistance to heat than the spar, and the spar having a greater strength than the airfoil shell; and
a radiant heat shield that circumscribes the spar within the internal cavity, the radiant heat shield enclosed within the airfoil shell and having a reflectance to radiant heat that is greater than or equal to that of the spar.

2. The component of claim 1, wherein the radiant heat shield is at least partially spaced apart from an outer surface of the spar and an inner surface of the airfoil shell.

3. The component of claim 2, wherein the airfoil shell comprises a plurality of lateral extensions that extend away from the inner surface of the airfoil shell and space the radiant heat shield away from the inner surface of the airfoil shell.

4. The component of claim 2, wherein the outer surface of the spar comprises a plurality of lateral extensions that extend away from the outer surface of the spar and space said radiant heat shield away from the outer surface of the spar.

5. The component of claim 1, wherein the radiant heat shield continuously circumscribes the spar between the radially inner platform and the radially outer platform.

6. The component of claim 1, wherein the radiant heat shield discontinuously circumscribes the spar between the radially inner platform and the radially outer platform.

7. The component of claim 6, wherein the radiant heat shield continuously circumscribes a portion of the spar that extends from one of the radially inner platform and the radially outer platform.

8. The component of claim 6, wherein the radiant heat shield comprises:
a first portion that continuously circumscribes a portion of the spar that extends from the radially inner platform; and
a second portion that is separate from the first portion and circumscribes a portion of the spar that extends from the radially outer platform.

9. The component of claim 1, wherein the spar comprises a nickel alloy.

10. The component of claim 1, wherein the airfoil shell comprises a ceramic matrix composite (CMC) or an alloy comprising one or more of niobium, tantalum, tungsten, rhenium, and molybdenum.

11. The component of claim 1, wherein the radiant heat shield comprises an alloy comprising one or more of nickel, cobalt, and gold.

12. The component of claim 1, wherein:
the spar comprises a nickel alloy;
the airfoil shell comprises a ceramic matrix composite (CMC) or an alloy comprising one or more of niobium, tantalum, tungsten, rhenium, and molybdenum; and
the radiant heat shield comprises an alloy comprising one or more of nickel, cobalt, and gold.

13. The component of claim 1, wherein the radiant heat shield has an emissivity that is 1-50%.

14. The component of claim 1, wherein the radiant heat shield has a reflectance that is 50-99%.

15. The component of claim 1, wherein the radiant heat shield has an absorptivity that is 1-80%.

16. The component of claim 1, wherein the airfoil shell defines a first wall having a first thickness measured perpendicular to an outer surface of the spar, and the radiant heat shield defines a second wall having a second thickness measured perpendicular to the outer surface of the spar, and the first thickness is at least twice the second thickness.

17. The component of claim 1, wherein a portion of an internal cavity between the spar and the radiant heat shield is in fluid communication with a source of cooling air.

18. The component of claim 1, wherein the airfoil shell is part of a turbine vane.

19. A component for a gas turbine engine, comprising:
an airfoil shell having an internal cavity and extending between a radially inner platform and a radially outer platform, the airfoil shell comprising a ceramic matrix composite (CMC) or an alloy comprising one or more of niobium, tantalum, tungsten, rhenium, and molybdenum;
a spar disposed within the internal cavity, the airfoil shell having a greater resistance to heat than the spar, and the spar having a greater strength than the airfoil shell, the spar comprising a nickel alloy; and
a radiant heat shield that circumscribes the spar within the internal cavity, the radiant heat shield enclosed within the airfoil shell and having a reflectance to radiant heat that is greater than or equal to that of the spar, the radiant heat shield comprising an alloy comprising one or more of nickel, cobalt, and gold;
wherein the radiant heat shield is at least partially spaced apart from an outer surface of the spar and an inner surface of the airfoil shell; and
wherein the radiant heat shield has an emissivity that is 1-50%, a reflectance that is 50-99%, and an absorptivity that is 1-80%.

20. A gas turbine engine comprising:
a compressor section;
a combustor section in fluid communication with the compressor section; and
a turbine section in fluid communication with the combustor section, the turbine section including a turbine vane, the turbine vane comprising:
an airfoil shell having an internal cavity and extending between a radially inner platform and a radially outer platform;
a spar disposed within the internal cavity, the airfoil shell having a greater resistance to heat than the spar, and the spar having a greater strength than the airfoil shell; and
a radiant heat shield that circumscribes the spar within the internal cavity, the radiant heat shield enclosed within the airfoil shell and having a reflectance to radiant heat that is greater than or equal to that of the spar.
